(19) United States
(12) Patent Application Publication
(10) Pub. No.: US 2026/0311607 A1
(43) Pub. Date: Oct. 8, 2026

(54) TRAFFIC ALERT AND COLLISION AVOIDANCE EVENT AUTOFLIGHT CONTROL SYSTEM AND METHOD

(71) Applicant: THE BOEING COMPANY, Arlington, VA (US)

(72) Inventors: Luke Casey Hicks, Everett, WA (US); Emilia Pardo-Gomez, Getafe (ES); Dannah Ruth Gersh, Shoreline, WA (US); Jelmer Pascal Reitsma, Frankfurt am main (DE); Brian Kenyon Rupnik, Lake Stevens, WA (US); Alejandro Torres Gámiz, Madrid (ES); James Michael Gibson, Mukilteo, WA (US)

(21) Appl. No.: 19/098,576

(22) Filed: Apr. 2, 2025

(51) Int. Cl. G08G 5/80; G08G 5/21; G08G 5/58; G08G 5/72

(52) U.S. Cl. CPC G08G 5/80; G08G 5/21; G08G 5/58; G08G 5/723

(57) ABSTRACT

An aircraft includes a memory configured to store autoflight commands of a Traffic alert and Collision Avoidance System (TCAS) event autoflight mode and one or more processors. The one or more processors are configured to receive an indication of a Traffic Advisory (TA) and automatically arm the TCAS event autoflight mode. The one or more processors are further configured to receive an indication of a Resolution Advisory (RA) and automatically activate the TCAS event autoflight mode to automatically control the aircraft based on a type of the RA. The one or more processors are configured to receive an indication of a violation of an airspeed operational rule of the aircraft and perform an RA airspeed protection operation. The one or more processors are also configured to receive, an indication of a mode switch request to a TA-only mode and perform a TA mode transition response operation.

### FIELD OF THE DISCLOSURE

The present disclosure is generally related to aviation control systems, and more particularly, to control systems operating before, during, and after Traffic alert and Collision Avoidance System (TCAS) events.

### BACKGROUND

Some aircraft are equipped with a Traffic alert and Collision Avoidance System (TCAS) that monitors surrounding airspace to detect conflicts. A conflict occurs when a criterion is violated, such as a violation of a minimum vertical separation distance and/or minimum horizontal separation distance with another aircraft. These distances define an aircraft's protected zone, a volume of airspace surrounding the aircraft where entrance by another aircraft risks collision.

In response to potential conflicts, the TCAS sends advisories to the pilot. In some cases, pilots fail to respond to TCAS advisories in a timely manner or with appropriate responses (e.g., to maintain minimum separation distances). For example, in some high-altitude situations, pilots frequently instinctively overreact to TCAS events by overcontrolling the aircraft using unnecessarily aggressive maneuvering. Unnecessarily aggressive maneuvering can result in increased likelihood of injuries to aircraft crew, passengers, or both. Further, in some cases, a TCAS event can cause aircraft to deviate from a previous flight plan and it can be difficult for the pilot to quickly resume the previous flight plan after the TCAS event.

Accordingly, it is desirable to reduce a pilot's workload before, during, and after TCAS events. It is also desirable to provide information to pilots in a clear manner that allows pilots to quickly understand the situation. Additionally, it is desirable to mitigate effects of poor pilot response time and to provide support if a pilot is incapacitated.

### SUMMARY

In a particular implementation, an aircraft includes a memory configured to store autoflight commands of a Traffic alert and Collision Avoidance System (TCAS) event autoflight mode and one or more processors coupled to the memory. The one or more processors are configured to receive an indication of a Traffic Advisory (TA) corresponding to a TCAS event. The one or more processors are further configured to, in response to the indication of the TA, automatically arm the TCAS event autoflight mode. The one or more processors are further configured to receive an indication of a Resolution Advisory (RA) corresponding to the TCAS event. The one or more processors are further configured to, in response to the indication of the RA, automatically activate the TCAS event autoflight mode to automatically control the aircraft based on a type of the RA. The one or more processors are further configured to, prior to conclusion of the RA, receive an indication of a violation of an airspeed operational rule of the aircraft. The one or more processors are further configured to, in response to the indication of the violation, perform an RA airspeed protection operation, where the RA airspeed protection operation differs from a non-RA airspeed protection operation. The one or more processors are further configured to, prior to conclusion of the RA, receive an indication of a mode switch to a TA-only mode. The one or more processors are further configured to, in response to the indication of the mode switch, perform a TA mode transition response operation.

In a particular implementation, a method includes determining that a Traffic alert and Collision Avoidance System (TCAS) event state of the aircraft indicates a Resolution Advisory (RA). The method further includes receiving an indication of a violation of an airspeed operational rule of the aircraft. The method further includes, in response to the indication of the violation, performing an RA airspeed protection operation, where the RA airspeed protection operation is identified based on the indication of the RA and differs from a non-RA airspeed protection operation.

In a particular implementation, a non-transitory computer-readable medium stores instructions that, when executed by one or more processors of an aircraft, cause the one or more processors to perform operations including determining that a Traffic alert and Collision Avoidance System (TCAS) event state of the aircraft indicates a Resolution Advisory (RA). The operations further include, prior to conclusion of the RA, receiving an indication of a mode switch to a TA-only mode. The operations further include, in response to the mode switch, performing a TA mode transition response operation.

In a particular implementation, an aircraft includes a memory configured to store flight mode data and one or more processors coupled to the memory. The one or more processors are configured to receive an indication of conclusion of a Resolution Advisory (RA) of Traffic alert and Collision Avoidance System (TCAS) event. The one or more processors are further configured to, in response to receiving the indication of conclusion of the RA, automatically initiate a Post-Avoidance Maneuver (PAM), including retrieval of at least a portion of the flight mode data associated with a time period before detection of the RA. The PAM further includes identification of a pre-RA flight mode from the retrieved at least a portion of the flight mode data. The PAM further includes adjustment of control settings of the aircraft based on the pre-RA flight mode.

In a particular implementation, a method includes receiving, at an aircraft, an indication of conclusion of a Resolution Advisory (RA) of a Traffic alert and Collision Avoidance System (TCAS) event. The method further includes, in response to receiving the indication of conclusion of the RA, automatically executing, by the aircraft, a Post-Avoidance Maneuver (PAM), including retrieving stored pre-RA flight mode data of the aircraft. The PAM further includes identifying a pre-RA flight mode from the pre-RA flight mode data. The PAM further includes adjusting control settings of the aircraft based on the pre-RA flight mode.

In a particular implementation, a non-transitory computer-readable medium stores instructions that, when executed by one or more processors of an aircraft, cause the one or more processors to perform operations including receiving an indication of conclusion of a Resolution Advisory (RA) of a Traffic alert and Collision Avoidance System (TCAS) event. The operations further include, in response to receiving the indication, automatically initiating a Post-Avoidance Maneuver (PAM), including retrieving flight mode data associated with a time period before detection of the RA. The PAM further includes identifying a pre-RA flight mode from the retrieved flight mode data. The PAM further includes adjusting control settings of the aircraft based on the pre-RA flight mode.

The features, functions, and advantages described herein can be achieved independently in various implementations or can be combined in yet other implementations, further details of which can be found with reference to the following description and drawings.

### BRIEF DESCRIPTION OF THE DRAWINGS

FIG. 1 is a diagram that depicts a first example of a flight display that indicates a Traffic alert and Collision Avoidance System (TCAS) event status of an aircraft.

FIG. 2 is a diagram that depicts a first example of a control panel that can be used to control an aircraft during a TCAS event.

FIG. 3 is a diagram that depicts a second example of a flight display that indicates a TCAS event status of an aircraft.

FIG. 4 is a diagram that depicts a third example of a flight display that indicates a TCAS event status of an aircraft.

FIG. 5 is a diagram that depicts a fourth example of a flight display that indicates a TCAS event status of an aircraft.

FIG. 6 is a diagram that depicts a second example of a control panel that can be used to control an aircraft during a TCAS event.

FIG. 7 is a diagram that depicts an example of an instrument panel that can be used to control an aircraft during a TCAS event.

FIG. 8 is a diagram that depicts a fifth example of a flight display that indicates a TCAS event status of an aircraft.

FIG. 9 is a flowchart of a method of controlling an aircraft in response to a Resolution Advisory (RA) of a TCAS event.

FIG. 10 is a flowchart of a method of controlling an aircraft in response to an RA of a TCAS event.

FIG. 11 is a flowchart of a method of changing a TCAS event autoflight mode during an RA of a TCAS event.

FIG. 12 is a flowchart of a method of initiating a Post-Avoidance Maneuver (PAM) in response to conclusion of an RA of a TCAS event.

FIG. 13 is a block diagram of a computing environment including a computing device configured to support aspects of computer-implemented methods and computer-executable program instructions (or code) according to the present disclosure.

FIG. 14 is a flowchart illustrative of an example of a life cycle of an aircraft operated before, during, and after a TCAS event, in accordance with some examples of the subject disclosure.

FIG. 15 is a block diagram of a particular implementation of an aircraft associated with the life cycle of FIG. 14.

### DETAILED DESCRIPTION

A Traffic alert and Collision Avoidance System (TCAS) notifies an aircraft pilot of a potential collision situation (a TCAS event) and provides guidance for flying the aircraft out of the potential collision situation. However, during a TCAS event, pilots have many sources of information vying for their attention. Autoflight systems (e.g., flight decks and autopilot systems) are described herein that more clearly communicate information and assist pilots before, during, and after TCAS events, as compared to other flight decks and autopilot systems.

Some aircraft do not include integration between the TCAS and the autoflight system. In such aircraft, in some cases, because the autoflight system does not receive TCAS guidance during a TCAS event, the autoflight system would contradict pilot inputs, potentially worsening the TCAS event. As a result, for some systems, standard procedure is for the pilot to disconnect the autoflight system to manually follow TCAS guidance. However, in some cases, the pilot manually following TCAS guidance can lead to undesirable delay or pilot error with respect to manually following the TCAS guidance.

In some implementations, an autoflight system described herein is configured to enter various predetermined control modes based on TCAS events, enabling the autoflight system to provide pilot assistance specific to the TCAS event. In response to detecting a TCAS event, such as an intruder aircraft entering into a first proximity region surrounding an aircraft, the TCAS sends a Traffic Advisory (TA) to the pilot of the aircraft, notifying the pilot of a potential collision situation. In some implementations, in response to the TA, the aircraft automatically arms a TCAS event autoflight mode that is configured to control the aircraft during specific TCAS events. If the TCAS determines that the intruder aircraft is likely to enter into a second proximity region surrounding the aircraft, a Resolution Advisory (RA) is provided to the pilot, notifying the pilot of a more urgent potential collision situation. In some cases, the TCAS determines that the intruder aircraft is likely to enter into the second proximity region based on a route of the intruder aircraft (e.g., based on a heading of the aircraft, a climb rate of the aircraft, a closure rate with the intruder aircraft, or any combination thereof). In some implementations, in response to the RA, the TCAS event autoflight mode is automatically activated (e.g., after a time delay) to assist the pilot with the RA. During operation in the TCAS event autoflight mode, the aircraft is controlled in accordance with a predetermined autoflight control mode (e.g., a vertical speed (V/S) protection mode). In some implementations, a member of the flight crew can override the autoflight system or set the TCAS to operate in a TA-only mode, which prevents the TCAS from identifying RAs.

In some implementations, in response to an indication of conclusion of an RA (e.g., a clear-of-conflict (CoC) status message), a Post-Avoidance Maneuver (PAM) is automatically initiated. In some cases, the PAM is identified based on a pre-RA flight mode and control settings of the aircraft are adjusted based on the PAM. For example, in some cases, the pre-RA flight mode is a tactical mode and the control settings are adjusted to engage a V/S mode that causes the aircraft to climb toward a predetermined altitude.

Accordingly, automated or semi-automated systems of the aircraft assist the pilot during and after the TCAS event, enabling the pilot to perform fewer activities during the TCAS event and, in some cases, increasing response time and accuracy.

The figures and the following description illustrate specific exemplary implementations. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific implementations or examples described below, but by the claims and their equivalents.

Particular implementations are described herein with reference to the drawings. In the description, common features are designated by common reference numbers throughout the drawings.

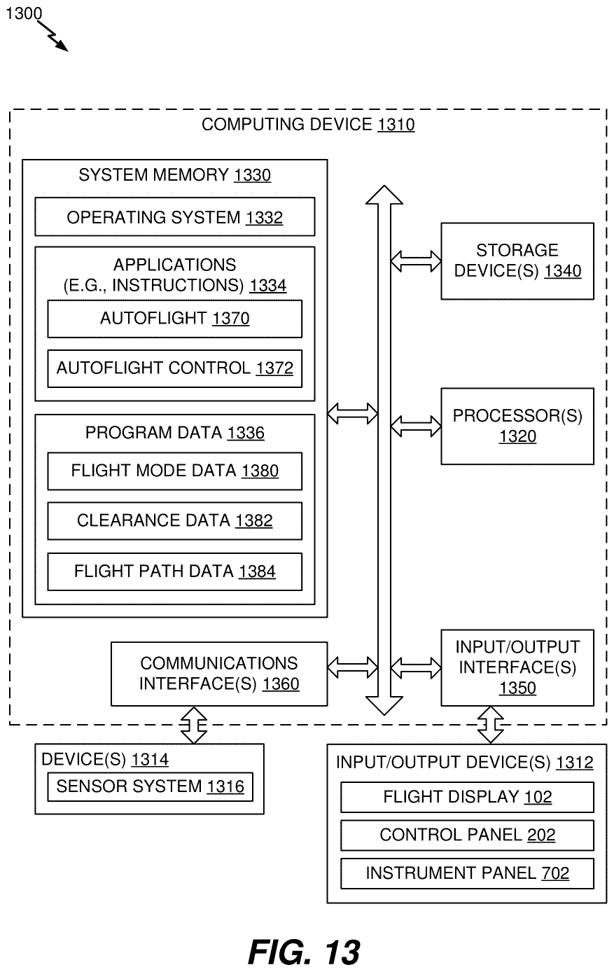

As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, FIG. 13 depicts a computing device 1310 including one or more processors (“processor(s)” 1320 in FIG. 13), which indicates that in some implementations the computing device 1310 includes a single processor 1320, and in other implementations the computing device 1310 includes multiple processors 1320. For ease of reference herein, such features are generally introduced as “one or more” features and are subsequently referred to in the singular or optional plural (as typically indicated by “(s)”) unless aspects related to multiple of the features are being described.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components.

Within this disclosure, in some cases, different entities (which are variously referred to as “components,” “units,” “devices,” etc.) are described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. Further, the term “configured to” is not intended to mean “configurable to.” An unprogrammed field-programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

This application refers to actions performed by an “autopilot,” also referred to herein as an “autopilot system,” and an “autoflight,” also referred to herein as an “autoflight system.” An autoflight is understood to encompass at least an autopilot and a flight director. Although autopilot and autoflight are different, it is understood that they can perform similar actions in controlling an aircraft. As a result, these terms are used interchangeably herein.

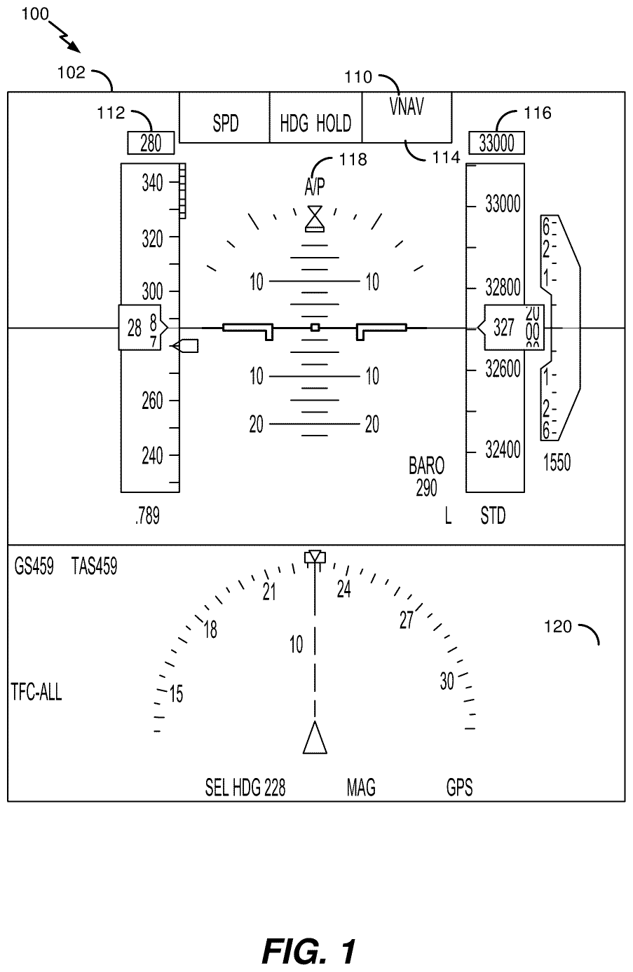

FIGS. 1-8 illustrate examples of various outputs and system configurations of an exemplary flight display, control panel, and instrument panel. The flight display, control panel, or instrument panel may be depicted before, during, or after a TCAS event. In some cases, each output and system configuration depicted by FIGS. 1-8 occurs in a single example and in others, an example shown in one figure may occur in a sequence with example(s) in other figures. In some cases, an example shown in one figure ends a sequence of events and the system is not configured in the arrangements shown in other figures. To illustrate, in one example, the flight display 102 of FIG. 1 depicts the output shown. However, in that example, the TCAS mode is never armed and a TCAS event never occurs, so the flight displays 302, 402, 502, and 802 are thus moot. In other words, the examples of FIGS. 1-8 are intended to be considered collectively, separately, and in any combination.

FIG. 1 is a diagram that illustrates a first example 100 of a flight display 102 that indicates a Traffic alert and Collision Avoidance System (TCAS) event status of an aircraft. The flight display 102 depicts an active mode field 110, a speed target field 112 commanded by an autoflight system, an armed mode field 114, an elevation target field 116 commanded by the autoflight system, an autoflight field 118, and a TCAS indication field 120.

In the first example 100, a TCAS event has not been detected (e.g., no other aircraft is nearby and a potential collision is not imminent) and the aircraft is operating normally. The autoflight is engaged and thus the autoflight field 118 indicates that autoflight is currently active (e.g., as opposed to flight director only operation). The active mode field 110 indicates that the aircraft is in a vertical navigation (VNAV) mode that helps pilots manage the aircraft's altitude during various phases of flight, such as takeoff, climb, cruise, descent, approach, and/or missed approach. The speed target field 112 indicates an airspeed target of 280 miles per hour (mph) and the elevation target field 116 indicates a target elevation of 33,000 feet in the specific example depicted by FIG. 1. The armed mode field 114 indicates that no modes are currently armed. The TCAS indication field 120 indicates that no TA or RA is detected. In some implementations, the aircraft records various settings of the aircraft (e.g., an autoflight setting (e.g., an altitude hold/capture setting, a vertical speed setting, a flight level change setting, a take-off/go-around (TO/GA) setting, an approach setting, whether an autopilot mode was armed, or any combination thereof), an autothrottle setting (e.g., a speed setting, an idle setting, a thrust setting, or any combination thereof), or any combination thereof). In some implementations, the settings are recorded periodically (e.g., based on a timer, based on a detected trigger condition, based on a user input, or the like).

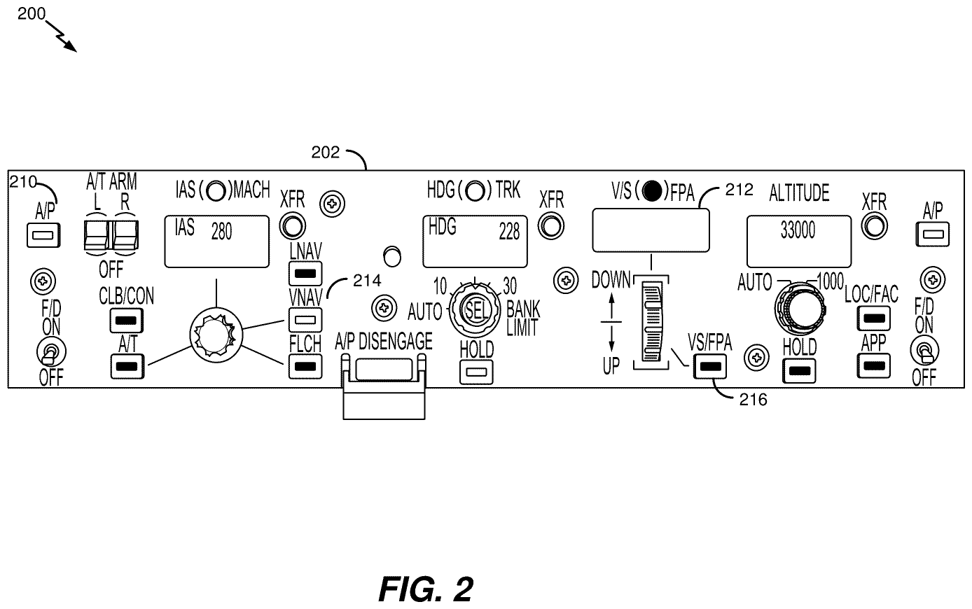

FIG. 2 is a diagram that depicts a first example 200 of a control panel 202 used to control an aircraft during a TCAS event. The control panel 202 includes an autopilot switch 210, a vertical speed (V/S) flight path angle (FPA) display 212, a VNAV indicator 214, and a V/S FPA indicator 216. In the illustrated implementation, the first example 200 corresponds to the first example 100 of FIG. 1 (e.g., the first example 200 occurs at the same time as the first example 100).

In the first example 200, a TCAS event has not been detected and the aircraft is operating normally. The autopilot switch 210 indicates that autopilot is currently enabled and can be pressed to disable the autopilot. The V/S FPA display 212 does not display anything because the aircraft is in VNAV mode. The VNAV indicator 214 indicates that a VNAV mode is enabled. The V/S FPA indicator 216 indicates that a V/S mode is disabled.

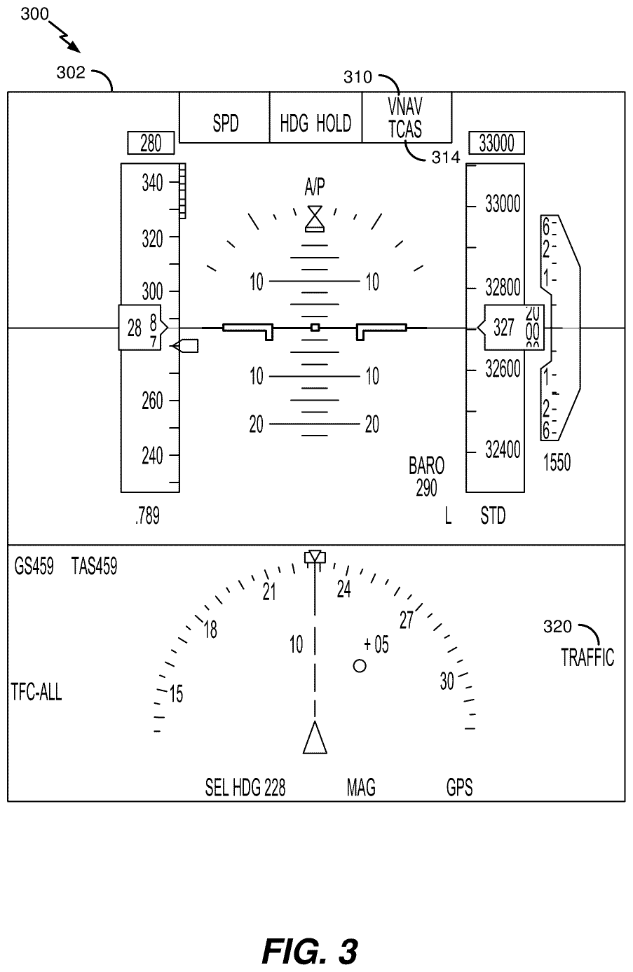

FIG. 3 is a diagram that illustrates a second example 300 of a flight display 302 that indicates a TCAS event status of an aircraft. The flight display 302 depicts an active mode field 310, an armed mode field 314, and a TCAS indication field 320. In some implementations, a control panel corresponding to the second example 300 has a same configuration as is depicted in the first example 200 of FIG. 2.

In the second example 300, an indication of a Traffic Advisory (TA) of a TCAS event has been received (e.g., from a TCAS). In response to the TA, a TCAS event autoflight mode is automatically armed (e.g., armed without specific instruction by the pilot subsequent to the indication of the TA). Similar to the first example 100 of FIG. 1, the active mode field 310 indicates that the aircraft is in a VNAV mode. However, unlike in the first example 100, the armed mode field 314 indicates that the TCAS event autoflight mode is currently armed, shown as a “TCAS” mode in FIG. 3. The TCAS indication field 320 also indicates that a TA or RA is detected, showing the word “TRAFFIC.” One of ordinary skill would understand that “TCAS” and “TRAFFIC” are just examples and in other implementations, other text/numbers/indicators/etc. could be displayed or provided. In some implementations, in response to receiving the indication of the TA, the aircraft records various settings of the aircraft (e.g., an autoflight setting (e.g., an altitude hold/capture setting, a vertical speed setting, a flight level change setting, a take-off/go-around (TO/GA) setting, an approach setting, whether an autopilot mode was armed, or any combination thereof), an autothrottle setting (e.g., a speed setting, an idle setting, a thrust setting, or any combination thereof), or any combination thereof).

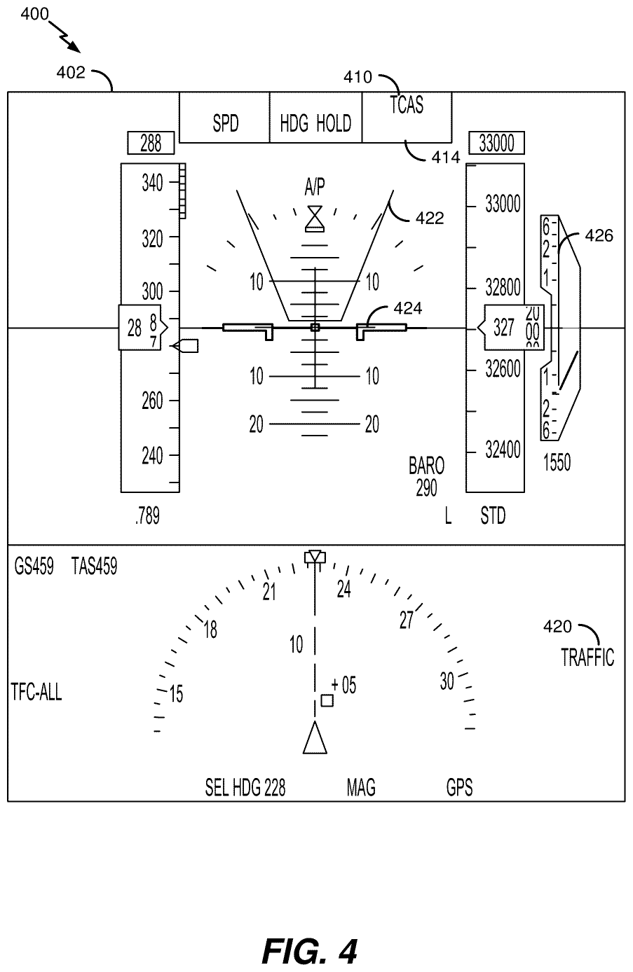

FIG. 4 is a diagram that illustrates a third example 400 of a flight display 402 that indicates a TCAS event status of an aircraft. The flight display 402 depicts an active mode field 410, an armed mode field 414, a TCAS indication field 420, a pitch trapezoid 422, flight director guidance 424, and vertical speed keep out zone indicator 426.

In the third example 400, an indication of a Resolution Advisory (RA) of a TCAS event has been received (e.g., from a TCAS). In some implementations, in response to receiving the indication of the RA, the aircraft records various settings of the aircraft (e.g., an autoflight setting (e.g., an altitude hold/capture setting, a vertical speed setting, a flight level change setting, a take-off/go-around (TO/GA) setting, an approach setting, whether an autopilot mode was armed, or any combination thereof), an autothrottle setting (e.g., a speed setting, an idle setting, a thrust setting, or any combination thereof), or any combination thereof). In response to the RA, a TCAS event autoflight mode is automatically activated (e.g., armed without specific instruction by the pilot subsequent to the indication of the RA). The TCAS event autoflight mode causes the autoflight to automatically control the aircraft in accordance with previously recorded settings. In some implementations, the TCAS event autoflight mode is automatically activated after a pre-defined time delay (e.g., 1 second, 5 seconds, or another delay duration) from the indication of the RA.

In the third example 400, the active mode field 410 indicates that the aircraft is in a TCAS event autoflight mode, shown as a “TCAS” mode. The armed mode field 414 indicates that no modes are currently armed. The pitch trapezoid 422 indicates an RA keep out region indicated by the TCAS. The flight director guidance 424 indicates a recommended course during the RA. In some implementations, due to the RA, the flight director guidance 424 is present regardless of whether flight director guidance is switched off for ordinary operations. The vertical speed keep out zone indicator 426 indicates a keep out zone on the vertical speed indicator of the flight display 402. The TCAS indication field 420 also indicates that a TA or RA is detected, showing the word “TRAFFIC.”

In some implementations, the autoflight controls the aircraft while in the TCAS event autoflight mode based on a type of the RA that is indicated. For example, some RAs do not warrant a deviation from a current flight path (e.g., because a current path is sufficient to avoid a potential collision) and thus the autoflight will not cause the aircraft to change course. Other RAs will cause the autoflight to climb/crossing climb, descend/crossing descend, increase climb/descent, reverse climb/descent, maintain climb/descent, or level-off. Different maneuvers can cause the autoflight to change the vertical speed of the aircraft, the acceleration rate, or both by differing amounts. In some cases, different circumstances during an RA (e.g., an intruder aircraft coming within a closer proximity or an intruder aircraft failing to perform an expected RA reaction procedure) can cause the autoflight in the TCAS event autoflight mode to respond more aggressively (e.g., accelerating more quickly or climbing at a higher angle). In some implementations, the appropriate RA guidance is computed by an integrated surveillance system (ISS) of the aircraft and provided to the autoflight. In some implementations, any TCAS alert (a TA indication, an RA indication, a CoC status message, etc.) can be received from the ISS.

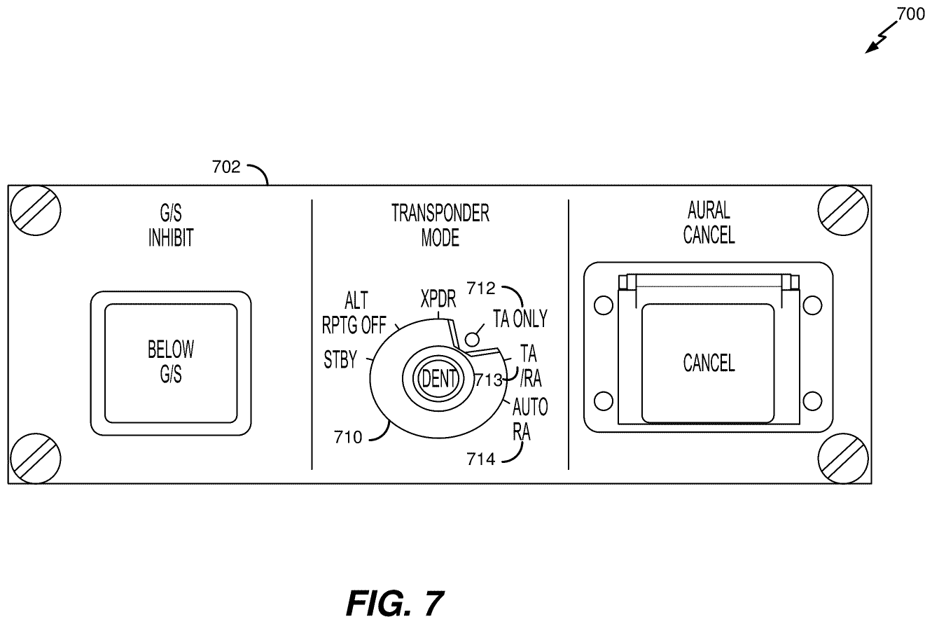

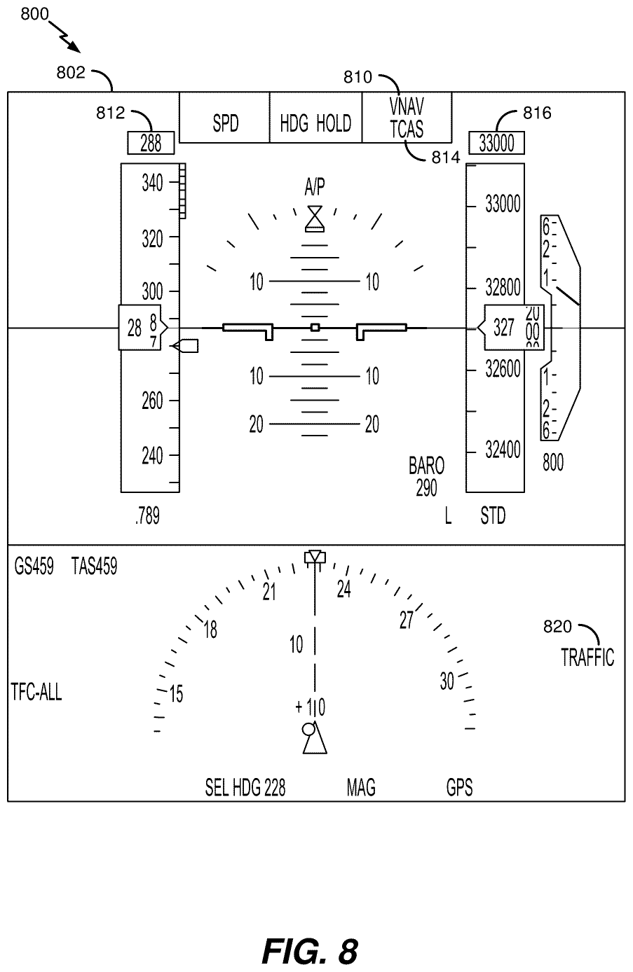

In some implementations, there are multiple ways to resolve an RA. For example, an RA can be resolved by a CoC status message generated due to resolution of the threat that caused the RA (e.g., an intruder aircraft leaving a specified proximity around the aircraft). In this case, as further described below with reference to FIG. 8, the RA is downgraded to a TA. In some implementations, a PAM is performed in response to receiving an indication of conclusion of the RA. As another example, an RA can be resolved by the aircraft being switched into a TA-only mode in which RAs are not detected. When the aircraft is switched into the TA-only mode, if an RA is active, the RA is downgraded to a TA without a CoC being issued. As further described below with reference to FIG. 7, a crew member such as a pilot can desire to disable an autoflight from entering the TCAS event autoflight mode and changes a setting of the aircraft, causing the RA to end and causing the TCAS to send an indication of a TA instead. As another example, an alert (e.g., an indication that a TCAS mode has failed, a warning from a Ground Proximity Warning System (GWPS), or a windshear alert) causes a mode switch request, causing the TCAS to stop indicating the RA and send an indication of a TA instead. As another example, the TCAS event autoflight stops sending some or all instructions, indications, or both in situations where an indication of a violation of an airspeed operational rule of the aircraft, such as a vertical speed (V/S) alert, is detected prior to conclusion of the RA. In some cases, an RA airspeed protection operation is performed, as opposed to a non-RA airspeed protection operation that would be performed during a violation of an airspeed operational rule detected when an RA is not active.

In some implementations, a violation of an airspeed operational rule, such as a V/S event, occurs when an aircraft is moving too quickly (overspeed) or too slowly (underspeed). An autoflight causes an aircraft to respond to overspeed events in one way and underspeed events in another. In some implementations, the autoflight described herein additionally causes the aircraft to respond to events based on whether an RA is active.

In some cases, violations of airspeed operational rules, such as V/S events, occur when an RA is not active. During non-RA violations of airspeed operational rules, the autoflight causes the aircraft to perform certain actions in response to a violation of an airspeed operational rule, referred to herein as a “non-RA airspeed protection operation.” In some implementations, the non-RA airspeed protection operation includes causing the aircraft to enter an underspeed protection mode, a stall protection mode, or both. In some implementations, the autoflight causes the aircraft to act differently during V/S events that occur when an RA is active. During RA violations of airspeed operational rules, the autoflight causes the aircraft to perform certain actions in response to a violation of an airspeed operational rule, referred to herein as an “RA airspeed protection operation,” where the RA airspeed protection operation differs from the non-RA airspeed protection operation. In some implementations, the RA airspeed protection operation includes causing the aircraft to perform one or more of an RA stall protection operation or an RA alpha floor underspeed protection operation. The RA stall protection operation is associated with instructions that, without entering the underspeed protection mode, control wing angles, flap position, lateral acceleration, or any combination thereof, to prevent the aircraft from entering a stall Angle of Attack (AoA). The RA alpha floor underspeed protection operation is associated with instructions that, without entering the underspeed protection mode, cause one or more engines of the aircraft to fire at full power in response to detecting that the aircraft is likely to stall.

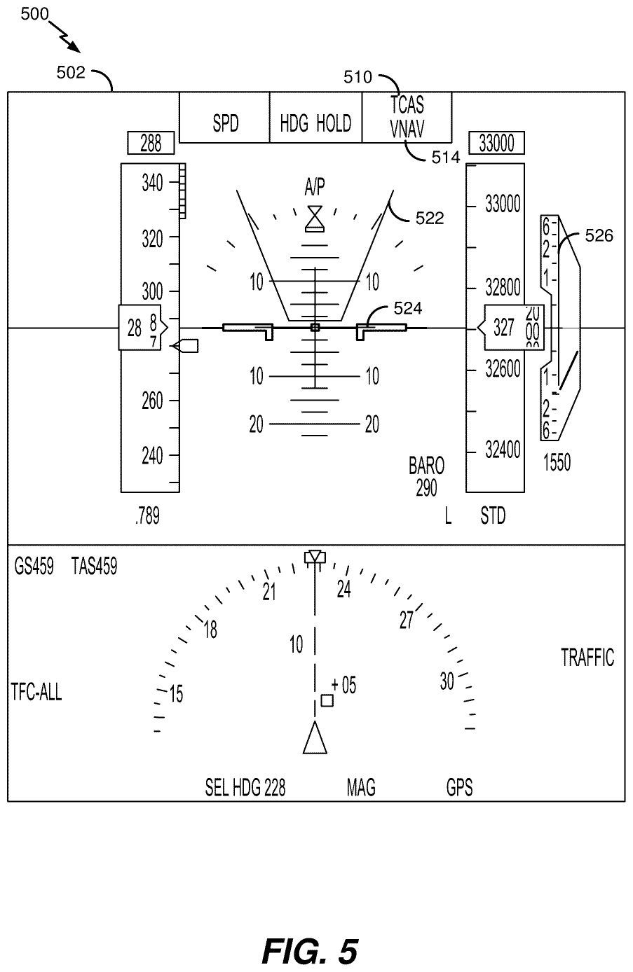

FIG. 5 is a diagram that illustrates a fourth example 500 of a flight display 502 that indicates a TCAS event status of an aircraft. The flight display 502 depicts an active mode field 510, an armed mode field 514, a pitch trapezoid 522, flight director guidance 524, and vertical speed keep out zone indicator 526.

In the fourth example 500, similar to the third example 400 of FIG. 4, an indication of an RA of a TCAS event has been received (e.g., from a TCAS) and the TCAS event autoflight mode is automatically activated. As discussed above with reference to FIGS. 1, 3, and 4, in some implementations, various settings of the aircraft (e.g., an altitude hold/capture setting, a vertical speed setting, a flight level change setting, a take-off/go-around (TO/GA) setting, an approach setting, a speed setting, an idle setting, a thrust setting, whether an autopilot mode was armed, or any combination thereof) are recorded. Based on the recorded settings, a type of RA indicated, actions performed during the RA, conditions of the aircraft (e.g., an altitude of the aircraft) or any combination thereof, a Post-Avoidance Maneuver (PAM) is determined. In some implementations, the PAM adjusts control settings of the aircraft based on a pre-RA flight mode to set the aircraft back on a pre-RA flight path.

In the fourth example 500, the active mode field 510 indicates that the aircraft is in a TCAS event autoflight mode, shown as a “TCAS” mode. The armed mode field 514 indicates that a V/S flight mode is to be activated as a PAM after conclusion of the RA. The pitch trapezoid 422 indicates an RA keep out region indicated by the TCAS. The flight director guidance 524 indicates a recommended course during the RA. In some implementations, due to the RA, the flight director guidance 524 is present regardless of whether flight director guidance is switched off for ordinary operations. The vertical speed keep out zone indicator 526 indicates a keep out zone on the vertical speed indicator of the flight display 502.

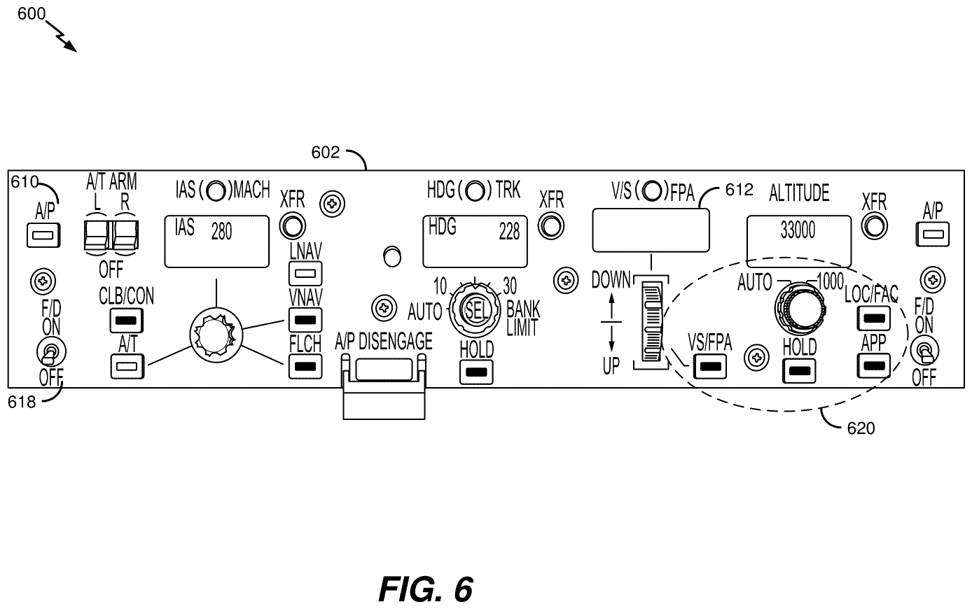

FIG. 6 is a diagram that depicts a second example 600 of a control panel 602 used to control an aircraft during a TCAS event. The control panel 602 includes an autopilot switch 610, a V/S FPA display 612, a flight director (F/D) switch 618, and a group of pitch axis push buttons 620. In the illustrated implementation, the second example 600 corresponds to the third example 400 of FIG. 4, the fourth example 500 of FIG. 5, or both.

In the second example 600, an RA has been detected and the autopilot has been enabled in the TCAS event autoflight mode. The autopilot switch 610 indicates that autopilot is currently enabled and can be pressed to disable the autopilot. The V/S FPA display 612 is blanked to notify the pilot that they do not have the ability to modify the V/S target for the TCAS event autoflight mode. As discussed above with reference to FIGS. 4 and 5, in some implementations, despite the F/D switch 618 being switched off, flight director guidance (e.g., the flight director guidance 424 or 524) is displayed due to the RA. The group of pitch axis push buttons 620 are not illuminated during the TCAS event.

FIG. 7 is a diagram that illustrates an example 700 of an instrument panel 702 that can be used to control an aircraft during a TCAS event. The instrument panel 702 includes a dial 710 that is used to cause the aircraft to switch between various modes, including a TA-only setting 712, a TA/RA setting 713, and an auto-RA setting 714. In some implementations, some modes are unavailable. For example, in some implementations, the auto-RA setting 714 is not present (e.g., because the TA/RA setting 713 enables the autoflight to automatically respond to RAs).

In some cases, a pilot can decide that automatic assistance from the TCAS during an RA is undesirable. In the system of the instrument panel 702, the pilot can use the dial 710 to cause the TCAS to perform a mode switch to various modes. For example, if the aircraft automatically enters a TCAS event autoflight mode due to an RA, the pilot can turn the dial 710 to the TA-only setting 712 to request that the TCAS perform a TA mode transition response operation to a TA-only mode in which RAs are not detected. Similarly, the pilot can turn the dial to the auto-RA setting 714 to enable the autoflight to automatically enter the TCAS event autoflight mode as described above with reference to FIGS. 1-6. In some implementations, setting the dial to the TA/RA setting 713 allows RAs to be issued but disables the autoflight (an autopilot, a flight director, or both) from providing an automatic response to an RA.

As described above, in some implementations, a pilot can desire to disable an autoflight from entering a TCAS event autoflight mode. Further, in some implementations, some conflicting alerts can trigger a mode switch request and cause the TCAS to perform a TA mode transition response operation. For example, in some implementations, a mode switch request is generated in response to receiving a warning from a Ground Proximity Warning System (GPWS), detection of a windshear alert, detection of failure of a TCAS mode, or detection that the RA has concluded. In some cases, the TA mode transition response operation causes the autoflight to exit the TCAS event autoflight mode.

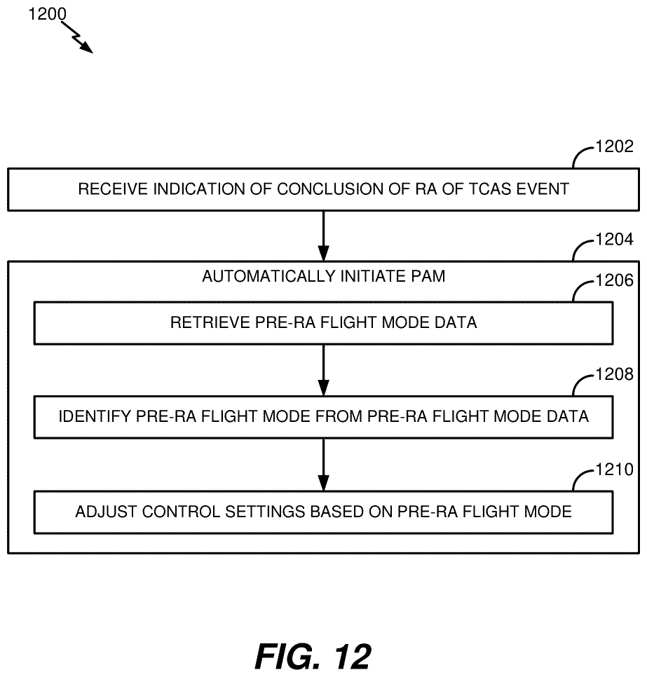

In some implementations, other events or systems can also trigger a mode switch request. Based on the cause of the mode switch request, the TA mode transition operation varies. For example, in response to detection of a failure of a TCAS mode, the TA mode transition response operation includes maintaining an input command received prior to the indication of the mode switch request and displaying, in a primary display configured to be shown within the aircraft (e.g., the flight display 102 of FIG. 1 or the V/S FPA display 212 of FIG. 2), an indication that a TCAS mode has failed (e.g., by showing TCAS as an active mode but with an additional failure indicator such as a strikethrough line that goes through the letters “TCAS”). In some cases, a situation occurs which triggers a mode switch request. For example, in response to detection of a warning from a GPWS, a windshear alert, or both, a take-off/go-around (TO/GA) mode or an automatic windshear response mode is engaged and the TCAS additionally transitions to the TA-only mode. In some implementations, in response to receiving an indication of the TA-only mode being set during an RA, despite no CoC status message being received for the RA, a PAM is initiated. The PAM is implemented in the same manner as the PAMs discussed below with reference to FIGS. 8 and 12.

FIG. 8 is a diagram that illustrates a fifth example 800 of a flight display 802 that indicates a TCAS event status of an aircraft. The flight display 802 depicts an active mode field 810, a speed target field 812, an armed mode field 814, an elevation target field 816, and a TCAS indication field 820. In some implementations, a control panel corresponding to the fifth example 800 has a same configuration as is depicted in the first example 200 of FIG. 2.

In the fifth example 800, an indication of conclusion of an RA has been received (e.g., via a CoC status message) but the TA has not yet concluded. In some implementations, the indication of the conclusion of the RA is received from an ISS of the aircraft. In other implementations, the indication of the conclusion of the RA is received from the TCAS. As a result, the flight display 802 is changed to depict the conclusion of the RA. The speed target field 812 indicates a target speed of 288 mph and the elevation target field 816 indicates a target elevation of 33,000 feet. Similar to the second example 300 of FIG. 3, the active mode field 810 indicates that the aircraft is in a VNAV mode and the armed mode field 814 is reverted to indicate that the TCAS event autoflight mode is currently armed. The TCAS indication field 820 indicates that a TA or an RA is detected, showing the word “TRAFFIC.”

Additionally, as discussed further below with reference to FIG. 12, in response to the indication of conclusion of the RA, the autoflight automatically initiates a PAM. As discussed above, various settings of the aircraft (e.g., flight mode data) are stored at one or more of various times (e.g., before detection of a TA, in response to detection of a TA, before detection of an RA, in response to detection of an RA, or any combination thereof). At least a portion of the flight mode data associated with a time period is retrieved. The time period is before detection of the TA, in response to detection of the TA, before detection of the RA, in response to detection of the RA, or any combination thereof. A pre-RA flight mode is detected from the retrieved flight mode data, and control settings of the aircraft are adjusted based on the pre-RA flight mode. Further, in some cases, adjustment of the control settings includes controlling the aircraft to return the aircraft to a pre-RA flight path.

To illustrate, in some cases, the pre-RA flight mode data includes an assigned clearance indicated by stored clearance data, and adjustment of the control settings includes causing the aircraft to be controlled toward the assigned clearance. In some cases, the pre-RA flight mode is a tactical mode or an approach mode, and the adjustment of the control settings includes engagement of a V/S mode that causes the aircraft to climb toward a predetermined altitude. In some cases, as illustrated by the armed mode field 814 of FIG. 8, the pre-RA flight mode is a VNAV mode, and one of several VNAV sub-modes are enabled. In some cases, the adjustment of the control settings includes re-engagement of the VNAV mode. In some cases, if the aircraft is below a predetermined altitude (e.g., below 1000 feet or below 5000 feet above ground level (AGL)) when the VNAV mode is engaged, the V/S mode is engaged. The V/S mode causes the aircraft to climb toward a set altitude, such as the altitude of the elevation target field 816. In some cases, the pre-RA flight mode is a TO/GA mode (e.g., because the aircraft was on approach prior to detection of the RA). In some cases, the adjustment of the control settings includes re-engagement of the TO/GA mode. In some cases, if the aircraft is below a predetermined altitude with the TO/GA mode is engaged, the TO/GA mode is overridden with the V/S mode. This can occur if a CoC status message for the aircraft is received when the aircraft is below a mode control panel (MCP) altitude. Additionally, the crew can enable various modes (e.g., TO/GA) if desired after a PAM is initiated.

Accordingly, systems of the aircraft assist the pilot during and after the TCAS event, enabling the pilot to perform fewer activities during the TCAS event. The displays are arranged in a way where it is clear to the pilot what the autoflight system is doing and will be doing. Further, because the autoflight system is used during the TCAS event, in some cases, response time and accuracy to an RA and events after an RA are increased.

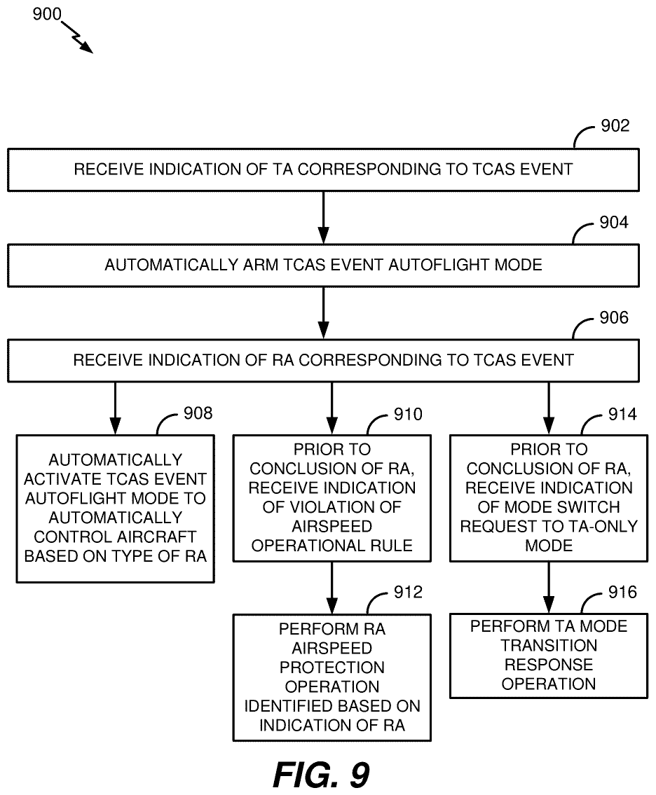

FIG. 9 is a flowchart of a method 900 of controlling an aircraft in response to an RA of a TCAS event. In some implementations, the method 900 is initiated by one or more processors in response to one or more instructions stored by a computer-readable storage medium. In some implementations, some portions of the method 900 do not occur, such as block 910 if block 914 occurs. In some implementations, some portions of the method 900 occur differently than depicted. For example, in some cases, block 910, block 914, or both occurs after block 908. Similarly, in some cases, block 908, block 914, or both occurs after block 912. As further discussed below with reference to FIG. 12, in some implementations, the method of FIG. 12 is performed subsequent to block 906 or 908.

The method 900 includes, at block 902, receiving an indication of a TA corresponding to a TCAS event. For example, as described with reference to FIG. 3, an indication of a TA is received.

The method 900 includes, at block 904, automatically arming a TCAS event autoflight mode. For example, as described with reference to FIG. 3, a TCAS event autoflight mode is armed in response to an indication of a TA.

The method includes, at block 906, receiving indication of an RA corresponding to the TCAS event. For example, as described with reference to FIG. 4, an indication of an RA is received. After block 906, one or more of blocks 908, 910, or 914 occurs.

The method 900 includes, at block 908, automatically activating a TCAS event autoflight mode to automatically control the aircraft based on a type of the RA. As described with reference to FIG. 4, in response to the RA, the autoflight causes the aircraft to perform different actions based on a type of the RA.

The method 900 includes, at block 910, prior to the conclusion of the RA, receiving an indication of a violation of an airspeed operational rule. As described with reference to FIG. 4, in some cases, a violation of an airspeed operational rule, such as a V/S alert, is received prior to conclusion of an RA.

The method 900 includes, at block 912, performing an RA airspeed protection operation that is identified based on the indication of the RA. As described with reference to FIG. 4, in some cases, the autoflight responds to violations of airspeed operational rules differently depending on whether an RA is active. The RA airspeed protection operation is performed in response to the indication of the violation of an airspeed operational rule, and the RA airspeed protection operation differs from a non-RA airspeed protection operation.

The method 900 includes, at block 914, prior to the conclusion of the RA, receiving an indication of a mode switch request to a TA-only mode. As described with reference to FIG. 7, various conditions (e.g., manual override by the pilot, a conflicting emergency, failure of the TCAS, etc.) can cause generation of a mode switch request to a TA-only mode.

The method 900 includes, at block 916, performing a TA mode transition response operation. As described with reference to FIG. 7, a TA mode transition response operation is performed in response to an indication of a mode switch request to transition to the requested mode.

Accordingly, a method of controlling an aircraft in response to an RA of a TCAS event and changing a TCAS event autoflight mode during the RA is depicted.

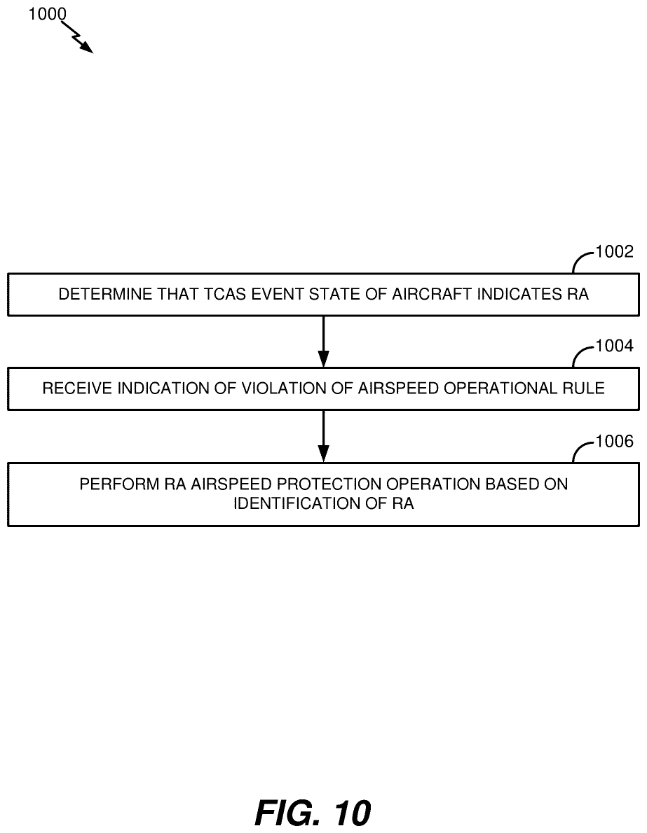

FIG. 10 is a flowchart of a method 1000 of controlling an aircraft in response to an RA of a TCAS event. In some implementations, the method 1000 is initiated by one or more processors in response to one or more instructions stored by a computer-readable storage medium. As further discussed below with reference to FIG. 12, in some implementations, the method 1200 occurs subsequent to block 1006 of FIG. 10.

The method 1000 includes, at block 1002 determining that a TCAS event state of the aircraft indicates an RA. For example, as described with reference to FIG. 4, an indication of an RA is received.

The method 1000 includes, at block 1004, prior to the conclusion of the RA, receiving an indication of a violation of an airspeed operational rule. As described with reference to FIG. 4, in some cases, a violation of an airspeed operational rule, such as a V/S alert, is received prior to conclusion of an RA.

The method 1000 includes, at block 1006, performing an RA airspeed protection operation that is identified based on the indication of the RA. As described with reference to FIG. 4, the autoflight responds to violations of airspeed operational rules differently depending on whether an RA is active. The RA airspeed protection operation is performed in response to the indication of the violation of an airspeed operational rule, and the RA airspeed protection operation differs from a non-RA airspeed protection operation.

Accordingly, a method of controlling an aircraft in response to an RA of a TCAS event is depicted.

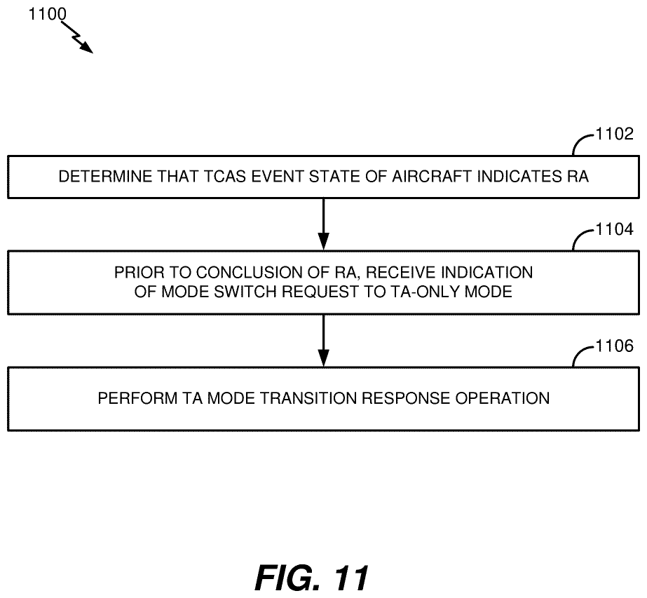

FIG. 11 is a flowchart of a method 1100 of changing a TCAS event autoflight mode during an RA of a TCAS event. In some implementations, the method 1100 is initiated by one or more processors in response to one or more instructions stored by a computer-readable storage medium.

The method 1100 includes, at block 1102, determining that a TCAS event state of an aircraft indicates an RA. For example, as described with reference to FIG. 4, an indication of an RA is received.

The method 1100 includes, at block 1104, prior to the conclusion of the RA, receiving an indication of a mode switch request to a TA-only mode. As described with reference to FIG. 7, various conditions (e.g., manual override by the pilot, a conflicting emergency, failure of the TCAS, etc.) can cause generation of a mode switch request to a TA-only mode.

The method 1100 includes, at block 1106, performing a TA mode transition response operation. As described with reference to FIG. 7, a TA mode transition response operation is performed in response to an indication of a mode switch request.

Accordingly, a method of changing a TCAS event autoflight mode during an RA of a TCAS event is depicted.

FIG. 12 is a flowchart of a method 1200 of automatically initiating a PAM in response to conclusion of an RA of a TCAS event. In some implementations, the method 1100 is initiated by one or more processors in response to one or more instructions stored by a computer-readable storage medium. In some implementations, the method 1200 occurs subsequent to block 906 or 908 of FIG. 9. In some implementations, the method 1200 occurs subsequent to block 1006 of FIG. 10.

The method 1200 includes, at block 1202, receiving an indication of conclusion of an RA of a TCAS event. For example, as described with reference to FIG. 8, an indication of conclusion of an RA of a TCAS event is received from an ISS of an aircraft.

The method 1200 includes, at block 1204, automatically initiating a PAM. For example, as described with reference to FIG. 8, a PAM is automatically initiated in response to an indication of conclusion of the RA.

Automatically initiating the PAM of block 1204 includes, at block 1206, retrieving pre-RA flight mode data. Automatically initiating the PAM of block 1204 includes, at block 1208, identifying a pre-RA flight mode from the pre-RA flight mode data. Automatically initiating the PAM of block 1204 includes, at block 1210, adjusting control settings based on the pre-RA flight mode. For example, as described with reference to FIG. 8, at least a portion of pre-RA flight mode data is retrieved, a pre-RA flight mode is identified from the retrieved at least a portion of the flight mode data, and control settings of the aircraft are adjusted based on the pre-RA flight mode (e.g., to restore the aircraft to a flight status prior to the RA).

Accordingly, a method of automatically initiating a PAM in response to conclusion of an RA of a TCAS event is depicted.

FIG. 13 is a block diagram of a computing environment 1300 including a computing device 1310 configured to support aspects of computer-implemented methods and computer-executable program instructions (or code) according to the present disclosure. For example, the computing device 1310, or portions thereof, is configured to execute instructions to initiate, perform, or control one or more operations described with reference to FIGS. 1-12, 14, and 15.

The computing device 1310 includes one or more processors 1320. The processor(s) 1320 are configured to communicate with a system memory 1330, one or more storage devices 1340, one or more input/output interfaces 1350, one or more communications interfaces 1360, or any combination thereof. The system memory 1330 includes volatile memory devices (e.g., random access memory (RAM) devices), nonvolatile memory devices (e.g., read-only memory (ROM) devices, programmable read-only memory, and flash memory), or both. The system memory 1330 stores an operating system 1332, which can include a basic input/output system for booting the computing device 1310 as well as a full operating system to enable the computing device 1310 to interact with users, other programs, and other devices. The system memory 1330 stores system (program) data 1336, such as flight mode data 1380, clearance data 1382, and flight path data 1384. In some implementations, the flight mode data 1380 indicates a flight mode of the aircraft at one or more points in time. The clearance data 1382 indicates information about clearance of the aircraft at one or more points in time. The flight path data 1384 indicates information about a flight path of the aircraft at one or more points in time. As described with reference to at least FIG. 4, the flight mode data can be stored periodically, prior to a TA, in response to a TA, prior to an RA, or in response to an RA.

The system memory 1330 includes one or more applications 1334 (e.g., sets of instructions) executable by the processor(s) 1320. As an example, the one or more applications 1334 include instructions executable by the processor(s) 1320 to initiate, control, or perform one or more operations described with reference to FIGS. 1-12, 14, and 15. To illustrate, the one or more applications 1334 include instructions executable by the processor(s) 1320 to initiate, control, or perform one or more operations described with reference to operations performed by the flight displays 102, 302, 402, 502, or 802, the control panels 202 or 602, the instrument panel 702, or a combination thereof. Additionally, the one or more applications 1334 include an autoflight application 1370 that, when executed, controls autoflight of the aircraft and an autoflight control application 1372 that, when executed, causes the autoflight application 1370 to enter various modes including a TCAS event autoflight mode.

In a particular implementation, the system memory 1330 includes a non-transitory, computer-readable medium storing the instructions that, when executed by the processor(s) 1320, cause the processor(s) 1320 to initiate, perform, or control operations to enable controlling an aircraft in response to an RA of a TCAS event, changing a TCAS event autoflight mode during an RA, initiating a PAM in response to conclusion of an RA, or any combination thereof.

The one or more storage devices 1340 include nonvolatile storage devices, such as magnetic disks, optical disks, or flash memory devices. In a particular example, the storage devices 1340 include both removable and non-removable memory devices. The storage devices 1340 are configured to store an operating system, images of operating systems, applications (e.g., one or more of the applications 1334), and program data (e.g., the system program data 1336). In a particular aspect, the system memory 1330, the storage devices 1340, or both, include tangible computer-readable media. In a particular aspect, one or more of the storage devices 1340 are external to the computing device 1310.

The one or more input/output interfaces 1350 enable the computing device 1310 to communicate with one or more input/output device(s) 1312 to facilitate user interaction. For example, the one or more input/output interfaces 1350 can include a display interface, an input interface, or both. For example, the input/output interface 1350 is adapted to receive input from a user, to receive input from another computing device, or a combination thereof. In some implementations, the input/output interface 1350 conforms to one or more standard interface protocols, including serial interfaces (e.g., universal serial bus (USB) interfaces or Institute of Electrical and Electronics Engineers (IEEE) interface standards), parallel interfaces, display adapters, audio adapters, or custom interfaces (“IEEE” is a registered trademark of The Institute of Electrical and Electronics Engineers, Inc. of Piscataway, New Jersey). In some implementations, the one or more input/output device(s) 1312 includes one or more user interface devices and displays, including some combination of buttons, keyboards, pointing devices, displays, speakers, microphones, touch screens, and other devices. In the illustrated implementation, the one or more input/output device(s) 1312 include the flight display 102 of FIG. 1, the control panel 202 of FIG. 2, and the instrument panel 702 of FIG. 7.

The processor(s) 1320 are configured to communicate with controllers or devices 1314 via the one or more communications interfaces 1360. For example, the one or more communications interfaces 1360 can include a network interface. In the illustrated implementation, the devices 1314 include a sensor system 1316 that monitors a state of the aircraft and that triggers TCAS events, TAs, RAs, or any combination thereof. In some implementations, the sensor system 1316 includes an ISS.

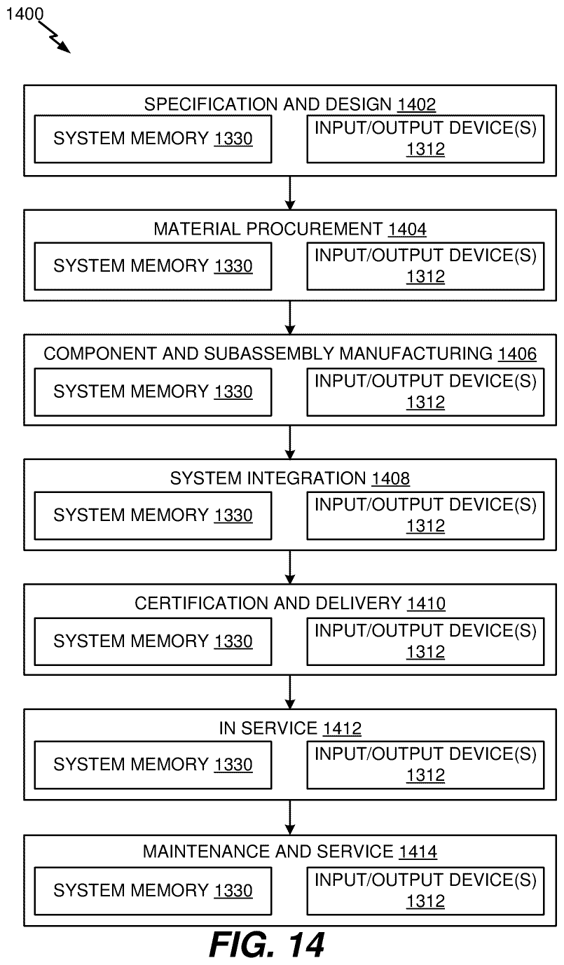

Referring to FIG. 14, a flowchart illustrative of an example method 1400 of a life cycle of an aircraft operated before, during, and after a TCAS event, in accordance with some examples of the subject disclosure. As described above with reference to FIG. 13, various applications and data used to operate an autoflight system of an aircraft through TCAS events are stored on the system memory 1330 and controlled and displayed using the input/output device(s) 1312. During pre-production, the exemplary method 1400 includes, at block 1402, specification and design of an aircraft. During specification and design of the aircraft, the method 1400 can include specification and design of the system memory 1330 and the input/output device(s) 1312. At block 1404, the method 1400 includes material procurement, which can include procuring materials for the system memory 1330 and the input/output device(s) 1312.

During production, the method 1400 includes, at block 1406, component and subassembly manufacturing and, at block 1408, system integration of the aircraft. For example, the method 1400 can include component and subassembly manufacturing of the system memory 1330 and the input/output device(s) 1312 and system integration of the system memory 1330 and the input/output device(s) 1312. At block 1410, the method 1400 includes certification and delivery of the aircraft and, at block 1412, placing the aircraft in service. Certification and delivery can include certification of the system memory 1330 and the input/output device(s) 1312 to place the system memory 1330 and the input/output device(s) 1312 in service. While in service by a customer, the aircraft can be scheduled for routine maintenance and service (which can also include the resource-efficient retrofit, modification, reconfiguration, refurbishment, and so on). At block 1414, the method 1400 includes performing maintenance and service on the aircraft, which can include performing maintenance and service on the system memory 1330 and the input/output device(s) 1312. Alternatively, performing maintenance and service on the aircraft can include replacing the system memory 1330 and the input/output device(s) 1312 during a retrofit operation.

Each of the processes of the method 1400 can be performed or carried out by a system integrator, a third party, and/or an operator (e.g., a customer). For the purposes of this description, a system integrator can include without limitation any number of aircraft manufacturers and major-system subcontractors; a third party can include without limitation any number of venders, subcontractors, and suppliers; and an operator can be an airline, leasing company, military entity, service organization, and so on.

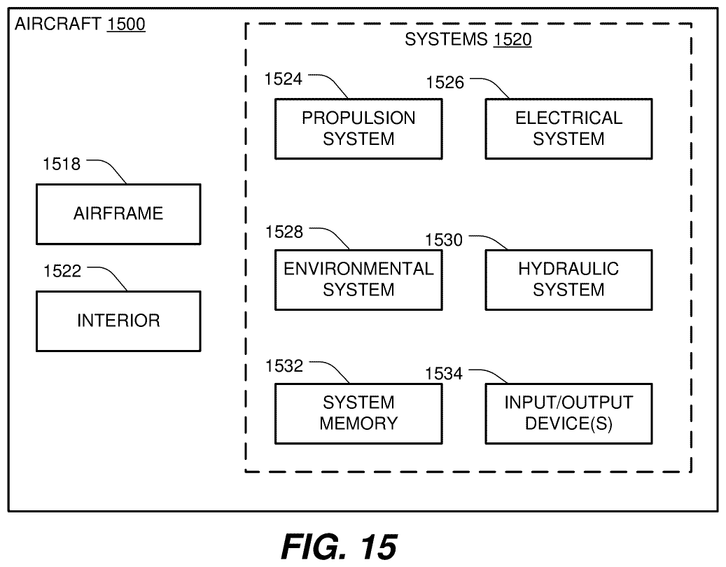

Aspects of the disclosure can be described in the context of an example of a vehicle. A particular example of a vehicle is an aircraft 1500 as shown in FIG. 15. In the example of FIG. 15, the aircraft 1500 includes an airframe 1518 with a plurality of systems 1520 and an interior 1522. Examples of the plurality of systems 1520 include one or more of a propulsion system 1524, an electrical system 1526, an environmental system 1528, a hydraulic system 1530, a system memory 1532, and input/output device(s) 1534. Any number of other systems can be included. In the example of FIG. 15, various applications and data used to operate an autoflight system of the aircraft 1500 through TCAS events are stored on the system memory 1532 and controlled and displayed using the input/output device(s) 1534. In some implementations, the system memory 1532 corresponds to the system memory 1330 and the input/output device(s) 1534 correspond to the input/output device(s) 1312.

In conjunction with the described systems and methods, an apparatus is disclosed that includes means for storing autoflight commands of a TCAS event autoflight mode. The apparatus also includes means for processing coupled to the means for storing autoflight commands and configured to receive an indication of a TA corresponding to a TCAS event, in response to the indication of the TA, automatically arm the TCAS event autoflight mode, receive an indication of a RA corresponding to the TCAS event, in response to the indication of the RA, automatically activate the TCAS event autoflight mode to automatically control the aircraft based on a type of the RA, prior to conclusion of the RA, receive an indication of a violation of an airspeed operational rule of the aircraft, in response to the indication of the violation, perform an RA airspeed protection operation, wherein the RA airspeed protection operation is identified based on the indication of the RA, and wherein the RA airspeed protection operation differs from a non-RA airspeed protection operation, prior to conclusion of the RA, receive an indication of a mode switch request to a TA-only mode, and in response to the indication of the mode switch request, perform a TA mode transition response operation.

In some implementations, the apparatus corresponds to the computing device 1310, the aircraft 1500, one or more other circuits or devices configured to receive digital data, or a combination thereof.

In conjunction with the described systems and methods, an apparatus is disclosed that includes means for storing flight mode data. The apparatus also includes means for processing coupled to the means for flight mode data and configured to receive an indication of conclusion of a RA of a TCAS event, and in response to receiving the indication of conclusion of the RA, automatically initiate a PAM, including: retrieval of at least a portion of the flight mode data associated with a time period before detection of the RA, identification of a pre-RA flight mode from the retrieved at least a portion of the flight mode data, and adjustment of control settings of the aircraft based on the pre-RA flight mode.

In some implementations, the apparatus corresponds to the computing device 1310, the aircraft 1500, one or more other circuits or devices configured to receive digital data, or a combination thereof.

In some implementations, a non-transitory, computer-readable medium stores instructions that, when executed by one or more processors, cause the one or more processors to initiate, perform, or control operations to perform part or all of the functionality described above. For example, the instructions can be executable to implement one or more of the operations or methods of FIGS. 1-15. In some implementations, part or all of one or more of the operations or methods of FIGS. 1-15 can be implemented by one or more processors (e.g., one or more central processing units (CPUs), one or more graphics processing units (GPUs), one or more digital signal processors (DSPs)) executing instructions, by dedicated hardware circuitry, or any combination thereof.

Further, the disclosure includes embodiments according to the following examples:

According to Example 1, an aircraft includes: a memory configured to store autoflight commands of a Traffic alert and Collision Avoidance System (TCAS) event autoflight mode; and one or more processors coupled to the memory and configured to: receive an indication of a Traffic Advisory (TA) corresponding to a TCAS event; in response to the indication of the TA, automatically arm the TCAS event autoflight mode; receive an indication of a Resolution Advisory (RA) corresponding to the TCAS event; in response to the indication of the RA, automatically activate the TCAS event autoflight mode to automatically control the aircraft based on a type of the RA; prior to conclusion of the RA, receive an indication of a violation of an airspeed operational rule of the aircraft; in response to the indication of the violation, perform an RA airspeed protection operation, wherein the RA airspeed protection operation is identified based on the indication of the RA, and wherein the RA airspeed protection operation differs from a non-RA airspeed protection operation; prior to conclusion of the RA, receive an indication of a mode switch request to a TA-only mode; and in response to the indication of the mode switch request, perform a TA mode transition response operation.

Example 2 includes the aircraft of Example 1, wherein the one or more processors are further configured to automatically activate the TCAS event autoflight mode after a pre-defined time delay from the indication of the RA.

Example 3 includes the aircraft of Example 1 or Example 2, wherein the one or more processors are further configured to, in response to an indication of conclusion of the RA and in response to a determination that the TA has not yet concluded, revert the TCAS event autoflight mode to armed.

Example 4 includes the aircraft of any of Example 1 to Example 3, wherein the one or more processors are further configured to, prior to the conclusion of the RA, disable the TCAS event autoflight mode in response to a pilot input.

Example 5 includes the aircraft of any of Example 1 to Example 4, wherein the one or more processors are configured to, in response to the TCAS event autoflight mode being automatically armed, indicate, in a primary display configured to be shown within the aircraft, that the TCAS event autoflight mode is armed.

Example 6 includes the aircraft of Example 5, wherein the automatically activating the TCAS event autoflight mode includes indicating, in the primary display, that the TCAS event autoflight mode is activated.

Example 7 includes the aircraft of any of Example 1 to Example 6, wherein the one or more processors are configured to, in response to the TCAS event autoflight mode being automatically activated, indicate, in a primary display configured to be shown within the aircraft, a speed target commanded by the TCAS event autoflight mode.

Example 8 includes the aircraft of any of Example 1 to Example 7, wherein the TCAS event corresponds to an intruder aircraft entering within a specified proximity to the aircraft.

Example 9 includes the aircraft of any of Example 1 to Example 8, wherein the RA corresponds to a determination that an intruder aircraft entering within a second specified proximity to the aircraft.

According to Example 10, a method includes: determining that a Traffic alert and Collision Avoidance System (TCAS) event state of the aircraft indicates a Resolution Advisory (RA); receiving an indication of a violation of an airspeed operational rule of the aircraft; and in response to the indication of the violation, performing an RA airspeed protection operation, wherein the RA airspeed protection operation is identified based on the indication of the RA and differs from a non-RA airspeed protection operation.

Example 11 includes the method of Example 10, wherein the non-RA airspeed protection operation is associated with instructions that cause the aircraft to enter an underspeed protection mode and a stall protection mode.

Example 12 includes the method of Example 11, wherein the RA airspeed protection operation is one of an RA stall protection operation or an RA alpha floor underspeed protection operation.

Example 13 includes the method of Example 12, wherein the RA stall protection operation is associated with instructions that, without entering the underspeed protection mode, control wing angles, flap position, lateral acceleration, or any combination thereof, to prevent the aircraft from entering a stall Angle of Attack (AoA).

Example 14 includes the method of Example 12 or Example 13, wherein the RA alpha floor underspeed protection operation is associated with instructions that, without entering the underspeed protection mode, cause one or more engines of the aircraft to fire at full power in response to detecting that the aircraft is likely to stall.

Example 15 includes the method of any of Example 10 to Example 14, further including: prior to conclusion of the RA, receiving an indication of a mode switch request to a TA-only mode; and in response to the indication of the mode switch request, performing a TA mode transition response operation.

According to Example 16, a non-transitory computer-readable medium stores instructions, that, when executed by one or more processors of an aircraft, cause the one or more processors to perform operations including: determining that a Traffic alert and Collision Avoidance System (TCAS) event state of the aircraft indicates a Resolution Advisory (RA); prior to conclusion of the RA, receiving an indication of a mode switch request to a TA-only mode; and, in response to the indication of the mode switch request, performing a TA mode transition response operation.

Example 17 includes the non-transitory computer-readable medium of Example 16, wherein the TA mode transition response operation includes: maintaining an input command received prior to the indication of the mode switch request; and displaying, in a primary display configured to be shown within the aircraft, an indication that a TCAS mode has failed.

Example 18 includes the non-transitory computer-readable medium of Example 16 or Example 17, wherein the TA mode transition response operation includes: causing the aircraft to perform a Post-Avoidance Maneuver (PAM), wherein a clear-of-conflict (CoC) status message for the RA has not been received.

Example 19 includes the non-transitory computer-readable medium of Example 16 to Example 18, wherein the mode switch request is generated in response to receiving a warning from a Ground Proximity Warning System (GPWS) or detection of a windshear alert.

Example 20 includes the non-transitory computer-readable medium of Example 19, wherein the TA mode transition response operation includes engaging a take-off/go-around (TO/GA) mode or engaging an automatic windshear response mode.

Example 21 includes the non-transitory computer-readable medium of Examples 16 to Example 20, wherein the operations further include: prior to conclusion of the RA, receiving an indication of a violation of an airspeed operational rule of the aircraft; and in response to the indication of the violation, performing an RA airspeed protection operation, wherein the RA airspeed protection operation is identified based on the indication of the RA, and wherein the RA airspeed protection operation differs from a non-RA airspeed protection operation.

According to Example 22, an aircraft includes: a memory configured to store flight mode data; and one or more processors coupled to the memory and configured to: receive an indication of conclusion of a Resolution Advisory (RA) of a Traffic alert and Collision Avoidance System (TCAS) event; and in response to receiving the indication of conclusion of the RA, automatically initiate a Post-Avoidance Maneuver (PAM), including: retrieval of at least a portion of the flight mode data associated with a time period before detection of the RA; identification of a pre-RA flight mode from the retrieved at least a portion of the flight mode data; and adjustment of control settings of the aircraft based on the pre-RA flight mode.

Example 23 includes the aircraft of Example 22, wherein the adjustment of the control settings includes causing the aircraft to be controlled toward an assigned clearance indicated by clearance data stored at the memory.

Example 24 includes the aircraft of Example 22 or Example 23, wherein the pre-RA flight mode is a tactical mode or an approach mode.

Example 25 includes the aircraft of Example 24, wherein the adjustment of the control settings includes engagement of a vertical speed (V/S) mode that causes the aircraft to climb toward a predetermined altitude.

Example 26 includes the aircraft of any of Example 22 to Example 25, wherein the pre-RA flight mode is a vertical navigation (VNAV) mode.

Example 27 includes the aircraft of Example 26, wherein the adjustment of the control settings includes re-engagement of the VNAV mode.

Example 28 includes the aircraft of Example 26 or Example 27, wherein the adjustment of the control settings includes engagement of a vertical speed (V/S) mode that causes the aircraft to climb toward a first predetermined altitude in response to detection that the aircraft is below a second predetermined altitude.

Example 29 includes the aircraft of any of Example 22 to Example 28, wherein the pre-RA flight mode is a take-off/go-around (TO/GA) mode.

Example 30 includes the aircraft of Example 29, wherein the adjustment of the control settings includes re-engagement of the TO/GA mode.

Example 31 includes the aircraft of Example 29 or Example 30, wherein the adjustment of the control settings includes engagement of a vertical speed (V/S) mode that causes the aircraft to climb toward a first predetermined altitude in response to detection that the aircraft is below a second predetermined altitude.

According to Example 32, a method includes: receiving, at an aircraft, an indication of conclusion of a Resolution Advisory (RA) of a Traffic alert and Collision Avoidance System (TCAS) event; and, in response to receiving the indication of conclusion of the RA, automatically executing, by the aircraft, a Post-Avoidance Maneuver (PAM), including: retrieving stored pre-RA flight mode data of the aircraft; identifying a pre-RA flight mode from the pre-RA flight mode data; and adjusting control settings of the aircraft based on the pre-RA flight mode.

Example 33 includes the method of Example 32, further including capturing, by the aircraft, the flight mode data.

Example 34 includes the method of Example 33, wherein said capturing the flight mode data is performed in response to detection of the TCAS event, in response to detection of the RA, or based on a timer.

Example 35 includes the method of any of Example 32 to Example 34, wherein the indication of the conclusion of the RA includes a clear-of-conflict status message.

Example 36 includes the method of any of Example 32 to Example 35, wherein said adjusting the control settings of the aircraft comprises automatically triggering a go-around maneuver in response to detecting that the aircraft was on approach prior to detection of the RA.

Example 37 includes the method of any of Example 32 to Example 36, wherein the indication of the conclusion of the RA is received from an integrated surveillance system (ISS) of the aircraft.

According to Example 38, a non-transitory computer-readable medium stores instructions, that, when executed by one or more processors of an aircraft, cause the one or more processors to perform operations including: receiving an indication of conclusion of a Resolution Advisory (RA) of a Traffic alert and Collision Avoidance System (TCAS) event; and in response to receiving the indication, automatically initiating a Post-Avoidance Maneuver (PAM), including: retrieving flight mode data associated with a time period before detection of the RA; identifying a pre-RA flight mode from the retrieved flight mode data; and adjusting control settings of the aircraft based on the pre-RA flight mode.

Example 39 includes the non-transitory computer-readable medium of Example 38, wherein the operations further include: subsequent to the adjusting the control settings of the aircraft and in response to receiving a crew input, initiating a second flight mode based on the crew input.

Example 40 includes the non-transitory computer-readable medium of Example 38 or Example 39, wherein the operations further include: retrieving pre-RA flight path data of the aircraft, wherein the adjusting the control settings of the aircraft is further based on a pre-RA flight path associated with the pre-RA flight path data.

Example 41 includes the non-transitory computer-readable medium of Example 40, wherein the adjusting the control settings of the aircraft includes controlling the aircraft to return the aircraft to the pre-RA flight path.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single implementation for the purpose of streamlining the disclosure. Examples described above illustrate but do not limit the disclosure. It should also be understood that numerous modifications and variations are possible in accordance with the principles of the present disclosure. As the following claims reflect, the claimed subject matter may be directed to less than all of the features of any of the disclosed examples. Accordingly, the scope of the disclosure is defined by the following claims and their equivalents.

What is claimed is:

1. An aircraft comprising:
a memory configured to store autoflight commands of a Traffic alert and Collision Avoidance System (TCAS) event autoflight mode; and
one or more processors coupled to the memory and configured to:
receive an indication of a Traffic Advisory (TA) corresponding to a TCAS event;
in response to the indication of the TA, automatically arm the TCAS event autoflight mode;
receive an indication of a Resolution Advisory (RA) corresponding to the TCAS event;
in response to the indication of the RA, automatically activate the TCAS event autoflight mode to automatically control the aircraft based on a type of the RA;
prior to conclusion of the RA, receive an indication of a violation of an airspeed operational rule of the aircraft;
in response to the indication of the violation, perform an RA airspeed protection operation, wherein the RA airspeed protection operation is identified based on the indication of the RA, and wherein the RA airspeed protection operation differs from a non-RA airspeed protection operation;
prior to conclusion of the RA, receive an indication of a mode switch request to a TA-only mode; and
in response to the indication of the mode switch request, perform a TA mode transition response operation.

2. The aircraft of claim 1, wherein the one or more processors are further configured to automatically activate the TCAS event autoflight mode after a pre-defined time delay from the indication of the RA.

3. The aircraft of claim 1, wherein the one or more processors are further configured to, in response to an indication of conclusion of the RA and in response to a determination that the TA has not yet concluded, revert the TCAS event autoflight mode to armed.

4. The aircraft of claim 1, wherein the one or more processors are further configured to, prior to the conclusion of the RA, disable the TCAS event autoflight mode in response to a pilot input.

5. The aircraft of claim 1, wherein the one or more processors are configured to, in response to the TCAS event autoflight mode being automatically armed, indicate, in a primary display configured to be shown within the aircraft, that the TCAS event autoflight mode is armed.

6. The aircraft of claim 5, wherein the automatically activating the TCAS event autoflight mode comprises indicating, in the primary display, that the TCAS event autoflight mode is activated.

7. The aircraft of claim 1, wherein the one or more processors are configured to, in response to the TCAS event autoflight mode being automatically activated, indicate, in a primary display configured to be shown within the aircraft, a speed target commanded by the TCAS event autoflight mode.

8. The aircraft of claim 1, wherein the TCAS event corresponds to an intruder aircraft entering within a specified proximity to the aircraft.

9. The aircraft of claim 1, wherein the RA corresponds to a determination that an intruder aircraft entering within a second specified proximity to the aircraft.

10. A method comprising:
determining that a Traffic alert and Collision Avoidance System (TCAS) event state of an aircraft indicates a Resolution Advisory (RA);
receiving an indication of a violation of an airspeed operational rule of the aircraft; and
in response to the indication of the violation, performing an RA airspeed protection operation, wherein the RA airspeed protection operation is identified based on the indication of the RA and differs from a non-RA airspeed protection operation.

11. The method of claim 10, wherein the non-RA airspeed protection operation is associated with instructions that cause the aircraft to enter an underspeed protection mode and a stall protection mode.

12. The method of claim 11, wherein the RA airspeed protection operation is one of an RA stall protection operation or an RA alpha floor underspeed protection operation.

13. The method of claim 12, wherein the RA stall protection operation is associated with instructions that, without entering the underspeed protection mode, control wing angles, flap position, lateral acceleration, or any combination thereof, to prevent the aircraft from entering a stall Angle of Attack (AoA).

14. The method of claim 12, wherein the RA alpha floor underspeed protection operation is associated with instructions that, without entering the underspeed protection mode, cause one or more engines of the aircraft to fire at full power in response to detecting that the aircraft is likely to stall.

15. The method of claim 10, further comprising:
prior to conclusion of the RA, receiving an indication of a mode switch request to a TA-only mode; and
in response to the indication of the mode switch request, performing a TA mode transition response operation.

16. A non-transitory computer-readable medium storing instructions, that, when executed by one or more processors of an aircraft, cause the one or more processors to perform operations comprising:
determining that a Traffic alert and Collision Avoidance System (TCAS) event state of the aircraft indicates a Resolution Advisory (RA);
prior to conclusion of the RA, receiving an indication of a mode switch request to a TA-only mode; and
in response to the indication of the mode switch request, performing a TA mode transition response operation.

17. The non-transitory computer-readable medium of claim 16, wherein the TA mode transition response operation comprises:
maintaining an input command received prior to the indication of the mode switch request; and
displaying, in a primary display configured to be shown within the aircraft, an indication that a TCAS mode has failed.

18. The non-transitory computer-readable medium of claim 16, wherein the TA mode transition response operation comprises:
causing the aircraft to perform a Post-Avoidance Maneuver (PAM), wherein a clear-of-conflict (CoC) status message for the RA has not been received.

19. The non-transitory computer-readable medium of claim 16, wherein the mode switch request is generated in response to receiving a warning from a Ground Proximity Warning System (GPWS) or detection of a windshear alert.

20. The non-transitory computer-readable medium of claim 19, wherein the TA mode transition response operation comprises engaging a take-off/go-around (TO/GA) mode or engaging an automatic windshear response mode.

21. The non-transitory computer-readable medium of claim 16, wherein the operations further comprise:
prior to conclusion of the RA, receiving an indication of a violation of an airspeed operational rule of the aircraft; and
in response to the indication of the violation, performing an RA airspeed protection operation, wherein the RA airspeed protection operation is identified based on the indication of the RA, and wherein the RA airspeed protection operation differs from a non-RA airspeed protection operation.
